(19) United States
(12) Patent Application Publication
(10) Pub. No.: US 2022/0281128 A1
(43) Pub. Date: Sep. 8, 2022

(54) Voice Writing Machine

(71) Applicant: James Timothy Struck, Waukegan, IL (US)

(72) Inventor: James Timothy Struck, Waukegan, IL (US)

(21) Appl. No.: 17/194,227

(22) Filed: Mar. 6, 2021

(51) Int. Cl. B26D 3/08; G10L 21/10

(52) U.S. Cl. CPC B26D 3/085; G10L 21/10

(57) ABSTRACT

Voice Writing machine shows how imprints or etches of voices can be imprinted on aluminum foil or other foil on cylinders that takes voice input from cone like input device. Other foil can be used to take the voice input too. Voice imprinting and voice writing can be studied for what kind of etches are made on different metal foils or paper. Voice writing machine shows a way imprints of voices can be taken or made on aluminum or other foil to take recordings of voices sounds. At the end of the cone, there are fibers or metal wire to record the voice on the foil. Voice writing machine shows a way of imprinting impressions of sounds on aluminum or other foil the way the voice produces a sketch on the cylinder foil. Voice writing machine shows a new way of recording voice signatures on metal or other foils.

### CROSS-REFERENCES TO RELATED APPLICATIONS

There was an earlier design application earlier in the year that was less extensive.

### STATEMENT REGARDING FEDERALLY SPONSORED RESEARCH OR DEVELOPMENT

Not applicable, but I do work with NASA but do not get funding.

### THE NAMES OF THE PARTIES TO A JOINT RESEARCH AGREEMENT

See 37 CFR 1.71 (g). Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

I did a previous design application earlier in the summer of 2020.

### STATEMENT REGARDING PRIOR DISCLOSURES BY THE INVENTOR OR A JOINT INVENTOR

I did a previous design application revealed to some companies earlier in the summer.

### BACKGROUND OF THE INVENTION

### Field of the Invention

The invention relates to the issue of study of how people, animals, or other voices sound and talk and how those voices can be recorded on metals or other materials.

### Description of the Related Art Including Information Disclosed Under 37 CFR 1.97 and 37 CFR 1.98

Thomas Alva Edison's phonograph had a vaguely similar appearance although it played what was on the round cylinder rather than recording the voice and studying the effect of sounds and voices on various metals like aluminum or other materials.

### BRIEF SUMMARY OF THE INVENTION

Voice Writing machine shows how imprints or etches of voices can be imprinted on aluminum foil or other foil on cylinders that takes voice input from cone like input device. Other foil can be used to take the voice input too.

Voice imprinting and voice writing can be studied for what kind of etches are made on different metal foils or paper. Voice writing machine shows a way imprints of voices can be taken or made on aluminum or other foil to take recordings of voices sounds. At the end of the cone, there are fibers or metal wire to record the voice on the foil.

Voice writing machine shows a way of imprinting impressions of sounds on aluminum or other foil the way the voice produces a sketch on the cylinder foil. Voice writing machine shows a new way of recording voice signatures on metal or other foils.

FIG. 1 or drawings show how the device or machine looks with foil over a cylinder rolled around while the voice writing device plays or makes a sketch on the foil. The sound recorded on the foil could also be played back into the cylinder.

A device to study sound and metals is provided.

### BRIEF DESCRIPTION OF THE SEVERAL VIEWS OF THE DRAWING(S)

FIG. 1 shows the voice writing device and its cone to talk into. I am trying to study if voice or voices have any effect or effects on a metal cylinder made of aluminum rather than the already known phonograph of Thomas Alva Edison with different design. What about aluminum? Here we allow people to study the voices effect on aluminum a widely available metal in alumni foil for example.

FIG. 2 shows the cylinder in which someone can talk or speak into onto the aluminum foil cylinder.

FIG. 3 shows the Voice writing machine with a broader longer size cylinder

FIG. 4 shows the Voice writing cone with a different material on the cone different number of tools to write sounds

FIG. 5 shows the Voice writing machine with a different material besides Aluminum on the cylinder on the machine

FIG. 6 shows the cone for the machine with a different number of pieces as the writing tool

FIG. 7 shows both voice writing machine and cone together with a different material on the cylinder and a tighter thinner writing instrument

FIG. 8 shows the cone with a different material on the cone and 4 writing pieces from the cone

FIG. 9 shows a thicker cylinder with a different material on the cylinder with a rotator attached to the writing machine over the support device

FIG. 10 shows a different material on the cone writing machine and a tighter writing piece

FIG. 11 shows view or perspective of the cylinder as a cylinder not flat

FIG. 12 shows the mount like cone for writing on the cylinder to study the reaction of voice on aluminum or other materials

FIG. 13 shows the voice writing machine spun around a support device with no lines of aluminum

FIG. 14 Shows a 3-pronged writing instrument for the voice sound cone

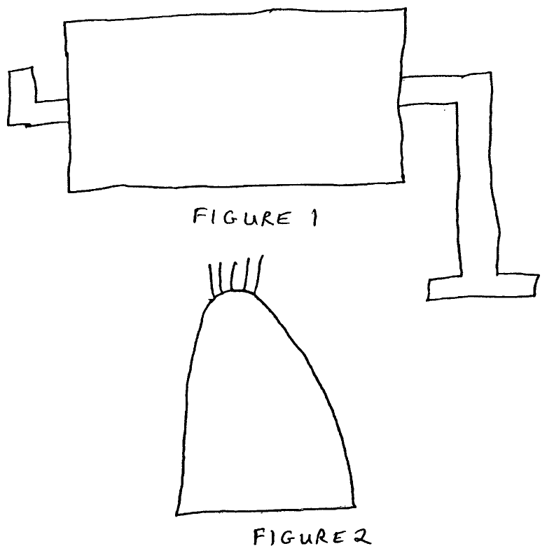

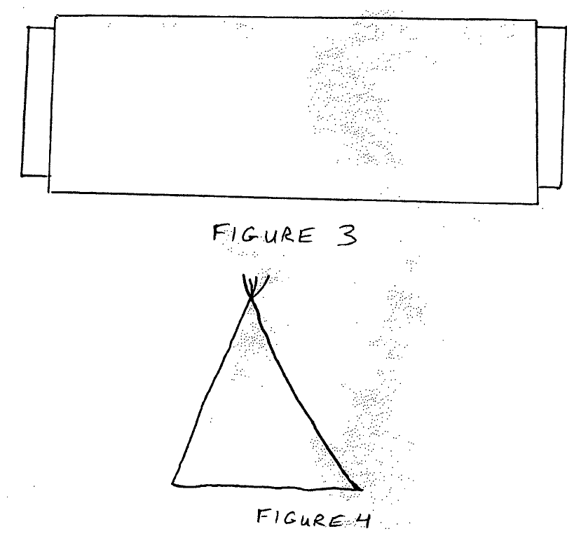

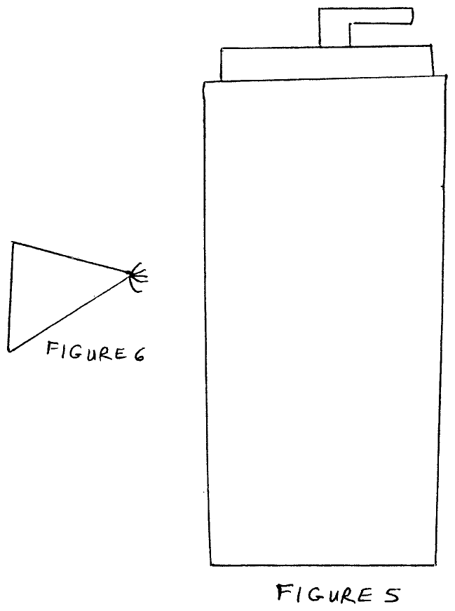

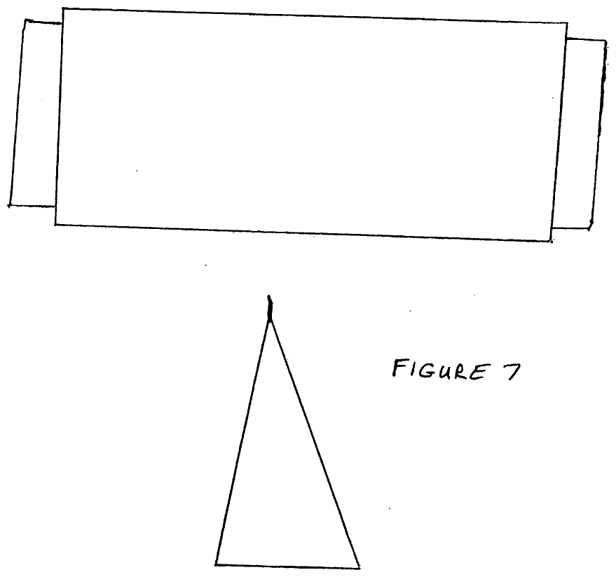

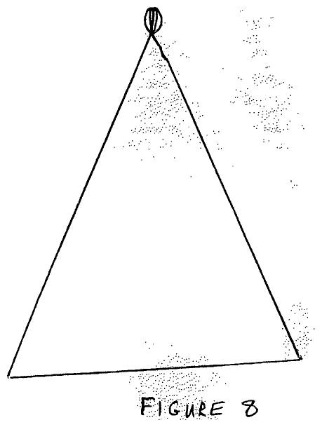

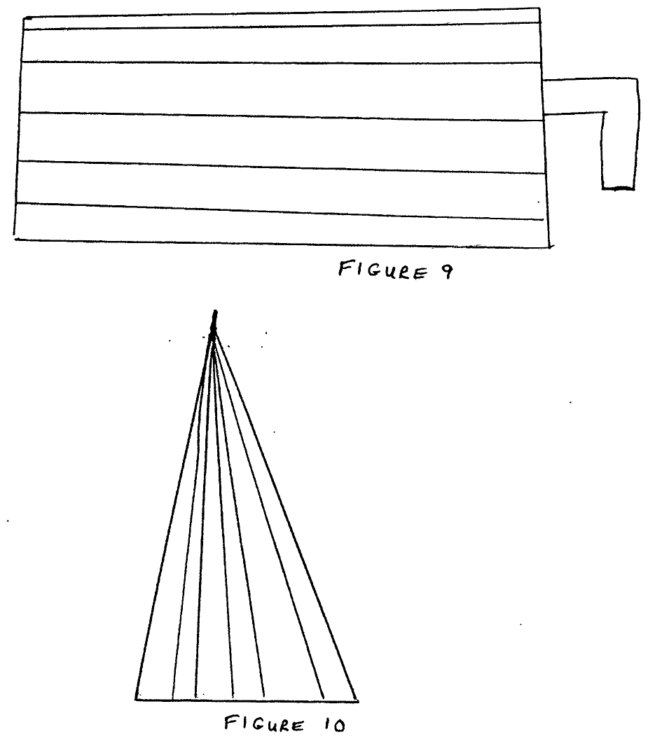

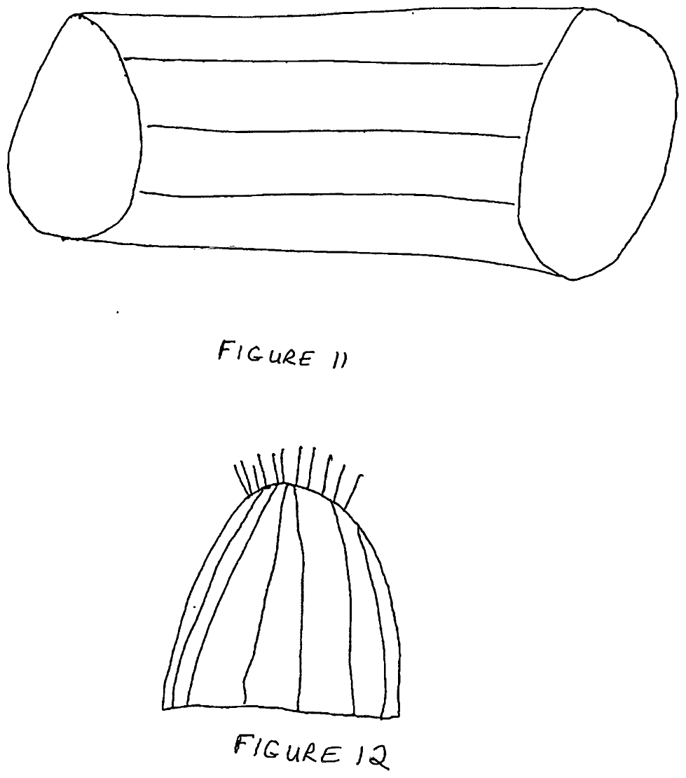

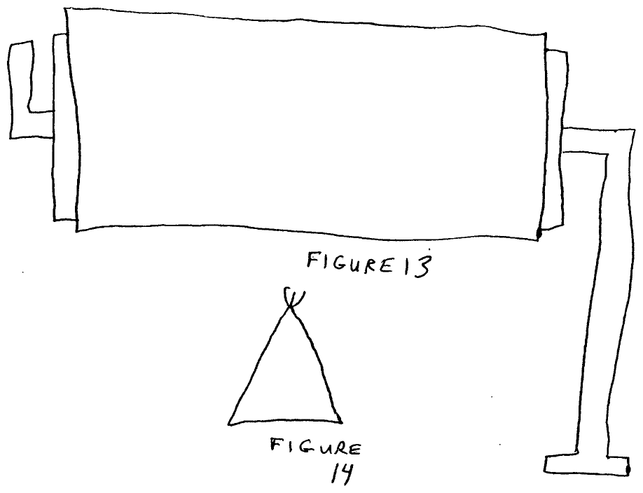

### DETAILED DESCRIPTION OF THE INVENTION

I show an invention to study the voice and voices and sounds and how it could be written on different kinds of metals like aluminum. I do not anticipate the voice or sounds will really be recordable or writable. My invention is only a studying or research device to study the effect of the voice or voices or sounds on aluminum or other metals. Other materials will have different effects when interacting with the cone and cylinder. Vinyl is used commonly as a recording device, but her I show that at least we can study other materials. The device would assist in showing recording or playing device could simply be cylinder structures connected to conical structures. A new kind of book or writing device could also be seen or invented also

1. Voice Writing machine shows how imprints or etches of voices can be imprinted on aluminum foil or other foil on cylinders that takes voice input from cone like input device. Other foil can be used to take the voice input too. Voice imprinting and voice writing can be studied.

2. Voice writing machine shows a way imprints of voices can be taken or made on aluminum or other foil to take recordings of voices sounds

3. Voice writing machine shows a way of imprinting impressions of sounds on aluminum or other foil the way the voice produces a sketch on the cylinder foil
